(19) United States
(12) Patent Application Publication
(10) Pub. No.: US 2016/0378836 A1
(43) Pub. Date: Dec. 29, 2016

(54) METHOD AND APPARATUS FOR CHARACTERIZING HUMAN RELATIONSHIPS USING SENSOR MONITORING

(71) Applicant: Anuj Kumar Purwar, Pleasanton, CA (US)

(72) Inventor: Anuj Kumar Purwar, Pleasanton, CA (US)

(21) Appl. No.: 15/058,101

(22) Filed: Mar. 1, 2016

Related U.S. Application Data
(63) Continuation-in-part of application No. 62/128,507, filed on Mar. 4, 2015.

(51) Int. Cl. G06F 17/30; G06F 19/00

(52) U.S. Cl. CPC G06F 17/30536; G06F 17/30528; G06F 19/3406

(57) ABSTRACT

A method and apparatus are provided for using data collected from personal sensors, such as those used to monitor health-related factors, to quantify fitness of human relationships. This is done by correlating the sensor data e.g. heart rate, accelerometer, GPS location, from personal electronic devices of users in a relationship, whether romantic, professional or otherwise, and using this data to represent the activities of the users and to characterize the physiological linkage and the emotional impact of those activities on each other. This data can be statistically analyzed to generate a relationship scorecard. By looking at trends of activities, such as stressful conflicts or pleasurable moments, it enables users to improve the quality of their relationships whether professional or personal or romantic.

### CROSS-REFERENCE TO RELATED APPLICATIONS: None

### FEDERALLY-SPONSORED RESEARCH: Not applicable.

### SEQUENCE LISTING: Not applicable.

### FIELD OF THE INVENTION

The present invention relates to personal electronic devices, particularly relating to characterization of user data from various sensors in personal electronic devices or from remote sensors connected to this personal electronic device.

### BACKGROUND

Personal electronic devices (smartphones or wearable devices such as iPhone, Apple Watch, or Fitbit) are frequently used to track health fitness by tracking steps walked via multiple sensors such as accelerometer, heart rate monitor, electro-dermal response, blood pressure, GPS and so on wherein these devices may exchange data wirelessly over computer networks (e.g. Wi-Fi or Bluetooth) with other devices like smartphones or tablets.

However, the need and opportunity exist to use the data collected from these sensors to quantify or qualify fitness of human relationships or specific interactions between two or more people, instead of just characterizing physical health. The present invention address this and other interrelationship needs in a unique and novel manner.

### BRIEF SUMMARY OF THE INVENTION

A method and apparatus for using data collected from personal sensors to quantify fitness of human relationships instead of just delivering health information is provided. Sensor data e.g. heart rate, GPS location, electro-dermal response, voice, from personal electronic devices of users in a relationship (could be romantic or professional) is correlated to infer mutual activities, look at trends over a period of time and to measure physiological linkage between the users and to characterize their emotional impact on each user. This data can be statistically analyzed to generate a relationship scorecard. The sensor data is sent to a processor based electronic device such as a smartphone by a communication link (either wirelessly or by wired communication link).

In one preferred embodiment the data from the sensors may be used to deduce the current activity between the two or more users who are in a relationship (e.g. marriage or employment). In another preferred embodiment, the sensors may be used to measure physiological linkage and quantify the users emotional response to events by looking at heart rate, physical proximity and electro-dermal response. In yet other preferred embodiment the personal electronic device just logs the time and location of an event (e.g. argument) manually flagged by the user and then communicates with remote sensors (e.g. a webcam) and asks it to save any recorded data for later review. In addition, user generated data such as calendar entries or location check-ins can be used to characterize the activities the users are participating in together whether in proximity or remotely.

In still yet another preferred embodiment, the sensor data is processed and analyzed either on the cloud i.e., on a remote server. The analysis involves classifying the mutual activity of the users e.g. in a meeting, or watching TV. Use sentiment analysis of voice and image data to quantify time the users are happy, sad, indifferent or angry and then calculate the emotional impact. This data can be correlated to generate a relationship “scorecard” and use Statistical Process Control methods to look at trends. In yet another embodiment, this generation of the relationship scorecard may be performed in the user device.

In still yet another preferred embodiment the device can use biometric measures like heart rate, skin conductance, and pulse transmission to calculate the physiological linkage by analyzing time series. The device can then give feedback to the users if the calculated physiological linkage is not in the optimal zone for the given situation e.g. conflict or regular meeting. In case of high stress situations, the feedback can be immediate by audio, visual or haptic means to assist the users de-escalate with tips to reduce stress around conflict.

The relationship activity data e.g. physiological linkage, sexual frequency, active/passive time spent together, may be displayed in a dashboard summarizing relationship metrics and compared to mean or median relationship activity levels of users in similar relationships and defined by a particular criteria (e.g. age, marital status, location) and then used as feedback to coach the users to improve their relationship scorecard. In still yet another preferred embodiment the score is compared relative to goals set either by users or by an interested party like a marital therapist or a manager.

### BRIEF DESCRIPTION OF THE DRAWINGS

FIG. 1 is a block diagram illustrating one example of a data collection process into a representative personal electronic device in accordance with the present invention.

FIG. 2 is a high level diagram indicating how the sensor data from the personal electronic devices of the users in a relationship is processed by classifying the activities and then using this to generate relationship parameters, which can be displayed to the users on the device or on a computer screen along.

FIG. 3 is a flowchart illustrating the correlation of data from multiple personal devices for computing a relationship scorecard.

FIG. 4 shows different types of graphs and numbers that can be shown to the users.

FIG. 5 shows how a marital engagement/satisfaction scorecard can be generated by combining processed data on the mutual activities of users as well as trends of the calculated physiological linkage numbers.

FIG. 6 shows a means for giving feedback to users based on the physiological linkage of users in a given mutual situation.

### DETAILED DESCRIPTION OF THE EMBODIMENTS

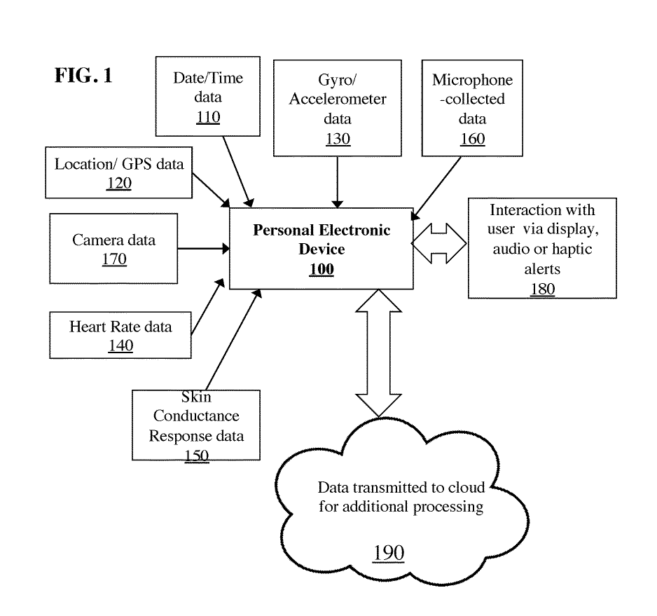

Referring now to FIG. 1, a functional block diagram 100 of an illustrative personal electronic device is shown. This device could be a personal device like a smart watch, fitness tracking band or larger processor based electronic devices like smartphone, personal media device, portable camera, tablet, notebook or desktop computer.

This device 100 can receive data from on-board devices and sensors of various types e.g. date/time 110, location tracking 120, gyroscope/accelerometer 130, heart rate tracking 140, pedometer, blood pressure sensor, electro-dermal response 150, microphone 160, camera/webcam 170, ambient light sensor. The device can also receive data from remote sensors via communication link The device might include a processor, display, user interface, memory and communication link The processor can be programmed to receive input data from the sensors and deduce the activity the users might be engaged in. This data can be sent to cloud 190 i.e., remote server for additional processing and analysis.

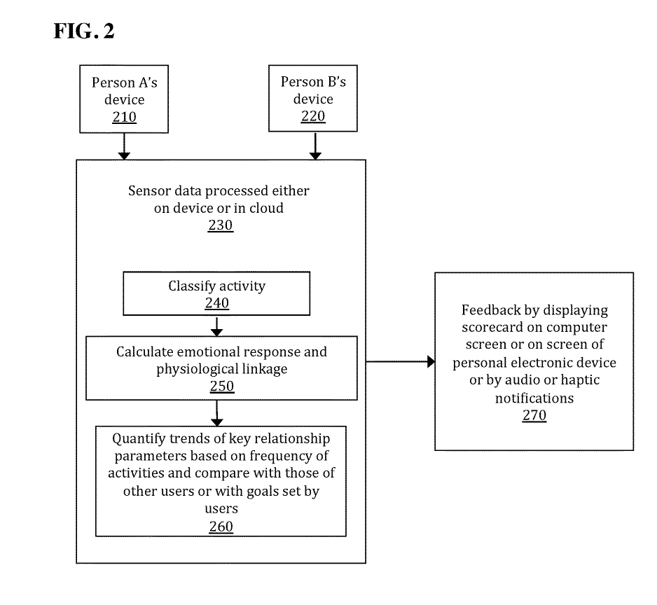

Referring now to FIG. 2, there is shown 200 how the relationship characterization data from the sensors may be combined according to certain embodiments. The sensor data from the personal electronic device of each user in a relationship e.g. User A 210 and User B 220 (can be more than two) is collected. The raw characterization data 230 from multiple users can be processed either on the device or on the cloud i.e., remote server. This analysis includes classification of the activity 240, calculation of emotional response and physiological linkage 250 followed by quantification of trends 260 of key relationship parameters based on frequency of activities and compare with those of other users or with goals set by the users. Based on this, the users in the relationship are given feedback by displaying scorecard on computer screen or on screen of personal electronic device or by audio or haptic notifications 270.

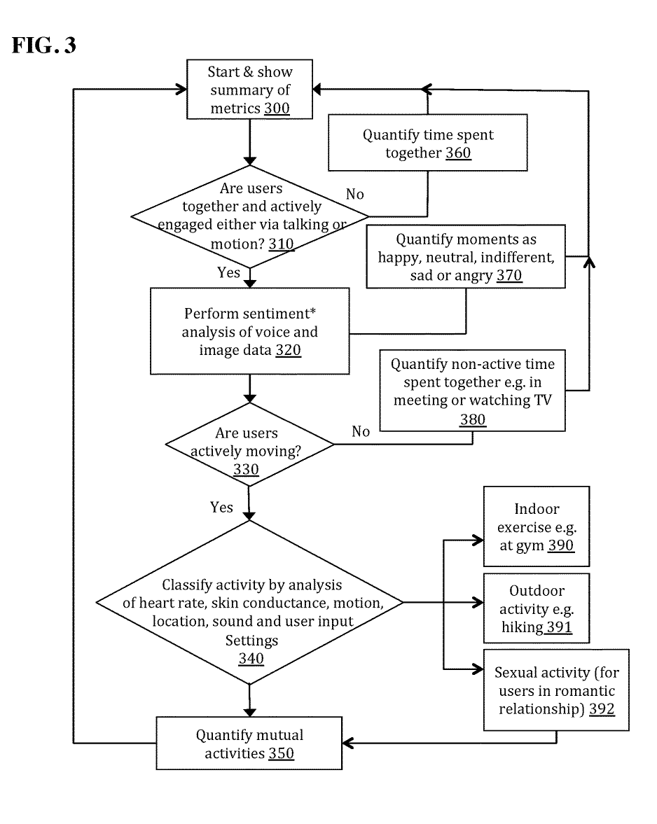

Referring now to FIG. 3, there is shown in the flowchart how the relationship metrics can be generated 300. If the users are together 310, the algorithm calculates the time spent together 360. If the users in the relationship are actively engaged e.g. talking or moving, the algorithm performs sentiment analysis 320 of the users' voice or images e.g. this could be done via a cloud API like by Emotient (Apple) or Google Cloud Vision API. The sentiment analysis can be use to quantify the moments 370 together as being happy, sad, indifferent or angry. If the users are actively moving 330, the activity can be classified 340 based on heart rate, location, skin conductance, sound or user input. For example the activities can be classified as indoor exercise, outdoor activity e.g. hiking, or sexual activity.

By way of example, if the heart rate of both husband and wife goes up together, when they are both in close proximity as determined by location tracking sensor, the skin conductance indicates increased tension and the microphone picks up loud high-pitched words then they might be having an argument. Alternatively above sensor data coupled with accelerometer motion data might indicate sexual activity rather than argument. After quantifying the activity, it can be displayed on the user's device or on a computer screen connected to the internet for cloud based analysis.

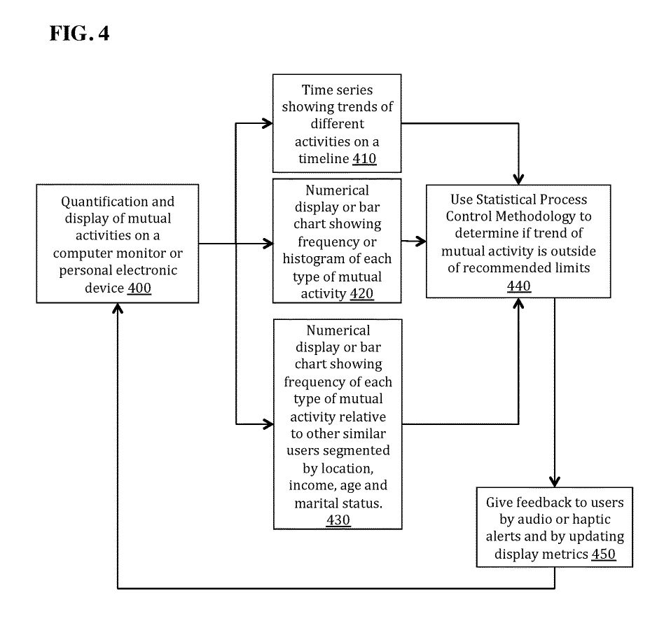

Referring now to FIG. 4, there is shown 400 how to quantify and display mutual activities of the users in a relationship on a computer monitor or personal electronic device. In one embodiment this information could be displayed as a time series showing trends of different activities on a timeline 410. In another embodiment the mutual activities could shown in numerical display 410 with mean and median values or a bar chart showing frequency or histogram of each type of activity. In yet another embodiment, the numerical display and frequency chart of the mutual activity can be shown relative to other similar users 430 segmented by location, income, age and marital status.

The numerical data can be analyzed using Statistical Process Control 440 methodology to determine if the trend of mutual activity is outside of baseline behavior or recommended values. When this happens, the device can give feedback 450 to the users by audio, visual or haptic alerts and by updating the display metrics.

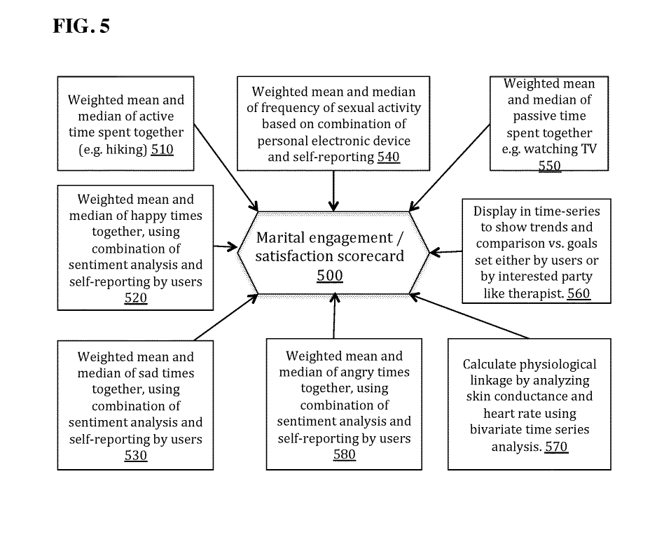

Referring now to FIG. 5, there is shown 500 a method to generate the marital engagement or satisfaction scorecard for users either married or in long term marriage like relationships. The scorecard can consist of elements:
i. 510 Weighted mean and median or active time spent together e.g. hiking.
ii. 520 Weighted mean and median of happy times together, using combination of sentiment analysis and self-reporting by users.
iii. 530 Weighted mean and median of sad times together, using combination of sentiment analysis and self-reporting by users.
iv. 540 Weighted mean and median of frequency of sexual activity based on combination of personal electronic device and self-reporting
v. 550 Weighted mean and median of passive time spent together e.g. watching TV
vi. 560 Display in time-series to show trends and comparison vs. goals set either by users or by interested party like therapist.
vii. 570 Calculate physiological linkage by analyzing skin conductance and heart rate using bivariate time series analysis
viii. 580 Weighted mean and median of angry times together, using combination of sentiment analysis and self-reporting by users

Tracking these data over a period of time will allow users in a romantic relationship to look at statistics of shared emotional states and events ranging from such as arguments, sex, or high adrenaline moments like skydiving. This scorecard can also be applied to professional relationships e.g. between employees and managers, allowing them to keep track of the emotional impact of events like annual performance reviews.

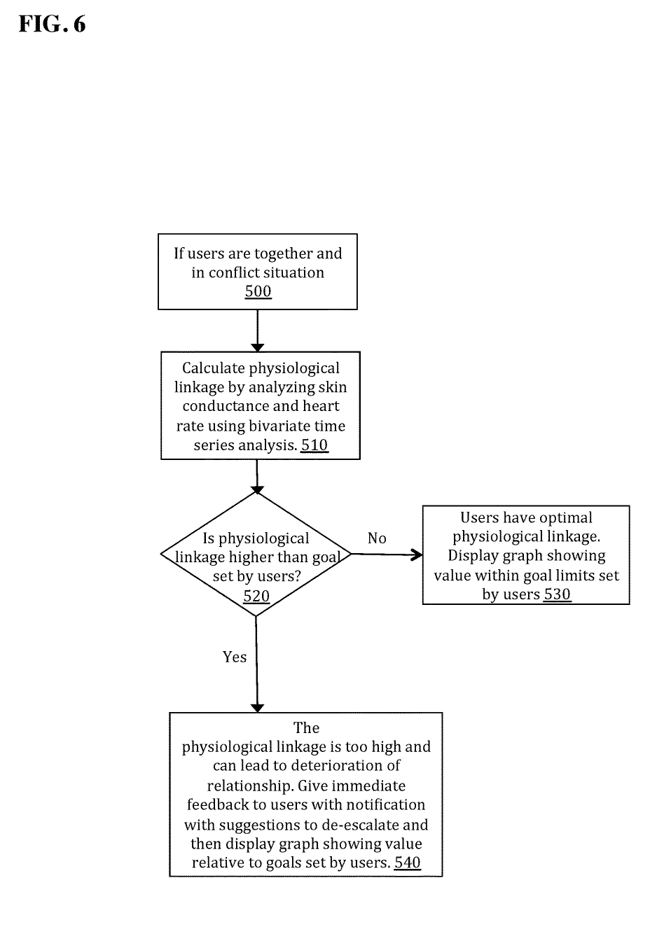

Referring now to FIG. 6, there is shown 500, a method to help users in a relationship to de-escalate during times of conflict. First the algorithm uses the sensor input to ascertain if the users are together and in a conflict situation 510. Then the sensor data including skin conductance, heart rate, pulse transmission rate is used to calculate the physiological linkage 520 using a bivariate time series analysis.

If the physiological linkage is lower than the control limits 530 either set by the users or interested third party like therapist or a preset value, then it means that the users have an optimal physiological linkage The display can show a graph showing the value within goal limits set by users. If on the other hand, the physiological linkage is higher than the control limits 540 either set by the users or interested third party like therapist or a preset value, then it means the physiological linkage is too high. A high physiological linkage can lead to deterioration of the relationship. In this case, immediate feedback is given to the users with alerts and suggestions to de-escalate and then display a graph showing the value relative to the goals or control limits

In one embodiment this information could be used to trigger audio/video recording and perhaps transcription of spoken words by remote link to a webcam. For example if device determines that husband and wife are arguing it could request DropCam (a wireless cloud connected camera service) to save footage from a particular time. This footage could be automatically transcribed by Google Voice or analyzed by a professional therapist.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A non-transitory program storage device comprising instructions stored thereon to cause one or more processors to:
aggregate sensor data inputs from electronic devices belonging to two or more different users in a relationship (professional or personal or romantic), associate the aggregated inputs with a mutual activity;
utilize aggregated inputs to characterize physiological response from the mutual activity;
generate an emotional impact rating based on the physiological response;
generate a relationship score based on statistical analysis of the physiological and emotional response of the mutual activity;
compare the relationship score with previous scores in that relationship and generate trend information; and
compare the relationship score with one or more similar relationship scores of other people in similar relationships.

2. The non-transitory program storage device as recited in claim 1 wherein the instructions to provide information to display a numerical or graphical representation of the emotional impact and relationship scores.

3. The non-transitory program storage device as recited in claim 1 wherein the instructions to associate comprise instructions to identify an emotional state based, at least in part, on the sensor readings.

4. The non-transitory program storage device as recited in claim 1 wherein the instructions to generate a score comprise instructions to:
average the relationship statistical data over a period of time; and, compare the averaged relationship statistical data with averaged relationship statistical data concerning similar relationships of other persons.

5. The non-transitory program storage device as recited in claim 1 further comprising instructions to publish, via the electronic device, information corresponding to the mutual activity of the users through a social media service.

6. The processor-based system comprising:
at least one processor;
at least one sensor responsive to the activity of the users in a relationship and in data communication with a processor; and,
a memory storing instructions for causing a processor to associate the aggregated inputs with a mutual activity;
generate an emotional rating based on physiological response for the mutual activity;

7. The non-transitory program storage device comprising instructions stored thereon to cause one or more processors to:
receive data from at least one sensor responsive to the mutual activity of the users in the relationship;
determine a likely mutual activity of the users in the relationship based at least in part on the sensor data and prior-acquired mutual activity data; and
compile statistics concerning the location and duration of the mutual activities of the users in the relationship.
